(19) United States
(12) Patent Application Publication
(10) Pub. No.: US 2011/0062095 A1
(43) Pub. Date: Mar. 17, 2011

(54) PRODUCT DISPLAY CASE

(75) Inventor: Giuseppe Tripodi, Casalecchio Di Reno (IT)

(73) Assignee: PLASTOTECH S.R.L., PONTECCHIO MARCONI (BOLOGNA) (IT)

(21) Appl. No.: 12/881,684

(22) Filed: Sep. 14, 2010

(30) Foreign Application Priority Data
Sep. 17, 2009 (IT) BO2009A000589

(51) Int. Cl. A47F 7/00; F16M 13/02

(52) U.S. Cl. 211/59.2; 248/250; 248/201

(57) ABSTRACT

A product display case comprises: a frame (2) comprising two vertical members (5), each vertical member (5) having an outside surface (7) and an inside surface (6), the inside surfaces (6) being positioned to face each other; and at least one shelf (3) which comprises a first end (8) and a second end (9), each engaged by a respective support (4) on each vertical member (5).

### BACKGROUND OF THE INVENTION

This invention relates to a product display case. More specifically, this invention is used for displaying goods of various kinds such as tools, confectionery, articles of clothing or others.

Prior art display cases are advantageously made from blank sheets of polypropylene, cardboard or other honeycomb material. These materials consist of two skins with a filling material interposed between them. To allow the blank sheets to be folded, fold lines are made in each sheet in order to locally weaken it.

More in detail, prior art display cases comprise a frame, which in turn comprises two side vertical members joined by a plurality of front strips made as one with the vertical members. The frame also comprises a rear wall having two lateral ends opposite each other. At each lateral end, there is a plurality of slots which house matching protuberances made on the vertical members in order to secure the rear wall to the vertical members. Thus, once assembled, the frame forms a box-shaped body.

Inserted in the box-shaped body, there is a supporting member. This supporting member comprises two side portions adjacent to the vertical members. These two side portions are joined by a plurality of front crosspieces made as one with the side portions. The upper portion of each front crosspiece is folded towards the inside of the box-shaped body of the container in such a way that it extends horizontally and remains perpendicular to the bottom portion, thereby forming an L-shaped support.

Shelves forming part of a plurality of shelves each rest on a respective horizontal portion of a respective support. Each shelf has two notches for receiving two shoulders present at the L-shaped support in such a way as to stop the shelf from sliding horizontally relative to the L-shaped support. The shelf also has two protuberances on the edge opposite the one that rests on the L-shaped support. These protuberances are slidably housed in slots made in the rear wall, in such a way that each shelf remains suspended between a respective front strip and the rear wall.

Prior art display cases have major drawbacks.

A shelf supported in the manner just described is stable under ordinary working conditions but is likely to collapse if struck accidentally, causing all the products on the shelf to fall. In particular, a blow on the rear wall of the display case may cause the shelf's protuberances to come out of the slots because the rear wall, which is made of a flexible material, can be elastically deformed.

Another drawback is due to difficulty of assembly. In effect, prior art display cases have a large number of components connected to each other in a complicated manner. For this reason, assembly of a prior art display case involves numerous steps, each relatively complex to carry out.

### SUMMARY OF THE INVENTION

In this context, the technical purpose which forms the basis of this invention is to propose a product display case that overcomes the above mentioned drawbacks of the prior art.

More specifically, this invention has for an aim to provide product display case whose shelves will not collapse even if struck accidentally.

Another aim of the invention is to provide a product display case that is easy to assemble and disassemble.

The technical purpose and aims specified are substantially achieved by a product display case comprising the technical features set out in one or more of the accompanying claims.

### BRIEF DESCRIPTION OF THE DRAWINGS

Further features and advantages of the invention are more apparent in the non-limiting description which follows of a preferred non-limiting embodiment of a product display case, as illustrated in the accompanying drawings, in which:

FIG. 1 is a perspective view of an embodiment of a product display case according to this invention;

FIGS. 2 and 3 are enlarged perspective views of a detail of the display case of FIG. 1 during different steps in its assembly;

FIGS. 4 to 7 are enlarged perspective views of an alternative embodiment of the detail of FIGS. 2 and 3 of the display case according to the invention during different steps in its assembly;

FIGS. 8 and 9 are enlarged perspective views of a further embodiment of the detail of FIGS. 2 and 3 of the display case according to the invention during different steps in its assembly.

### DESCRIPTION OF THE PREFERRED EMBODIMENTS

With reference to the accompanying drawings, the numeral 1 denotes in its entirety a product display case according to this invention.

The product display case 1 comprises a frame 2, whose function is that of supporting the shelves 3 which support products of various kinds placed on sale or simply on display.

The frame 2 in turn comprises two vertical members 5, each of which has an outside surface 7 and an inside surface 6. More specifically, the inside surfaces 6 face each other. Preferably, the inside surfaces 6 and the outside surfaces 7 of each vertical member 5 are parallel to each other. Also, preferably, the inside surfaces 6 of the vertical members 5 are parallel to each other.

Each shelf 3 comprises a first end 8 and a second end 9. At least one hole 10 is made in each end 8, 9 of the shelf 3.

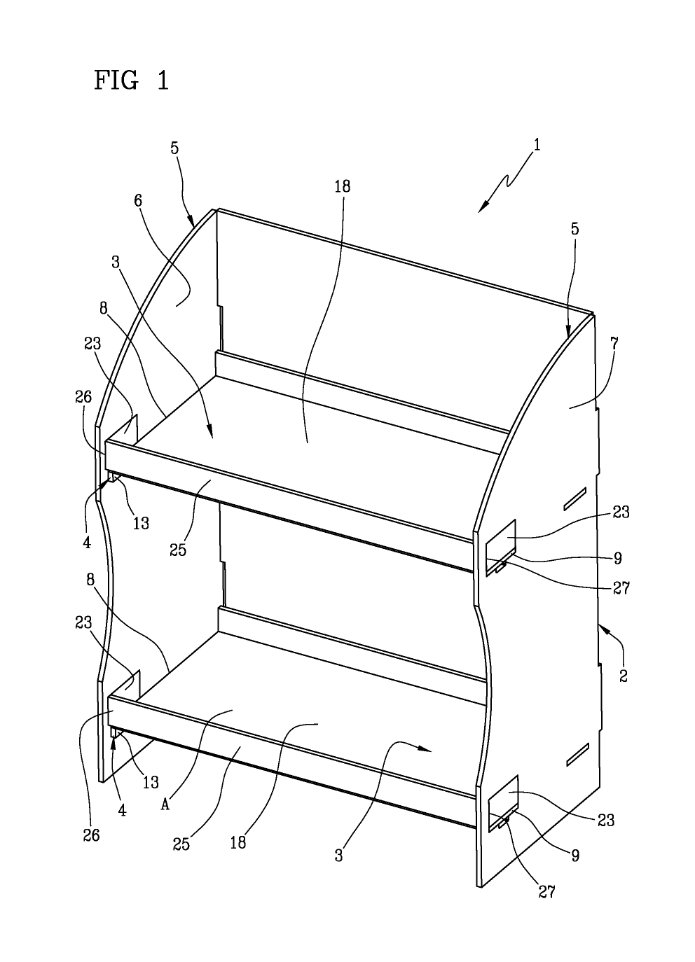

In the embodiment illustrated in FIG. 1, the product display case 1 comprises two shelves 3. The product display case 1 might, however, comprise any number of shelves 3.

The frame 2 also comprises at least two supports 4. Each support 4 is connected to a vertical member 5 in such a way as to support the shelf 3. Each support comprises a portion of vertical member 5 folded onto the inside surface 6 of the vertical member 5. In other words, the support 4 is obtained from the vertical member 5 and is made as one with the latter. Preferably, the support 4 is formed entirely from the folded portion of the vertical member 5.

Each support 4 comprises an upper edge 12 made as one with the vertical member. The upper edge 12 is in contact with an end 8, 9 of a shelf 3.

The support 4 also comprises two lateral edges 13 which extend from the upper edge 12.

On the opposite side of the upper edge 12, the lateral edges 13 are joined to each other by a bottom edge 14.

Each support 4 comprises a first wall and a second wall which are parallel to each other. The distance between the first wall of the support 4 and the second is equal to the distance between the inside surface 6 and the outside surface 7 of the respective vertical member 5 of the support 4.

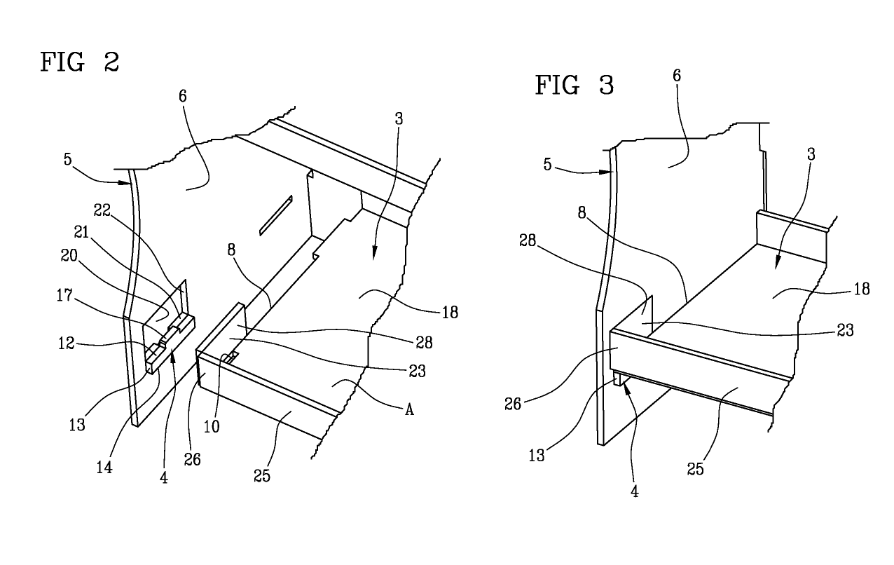

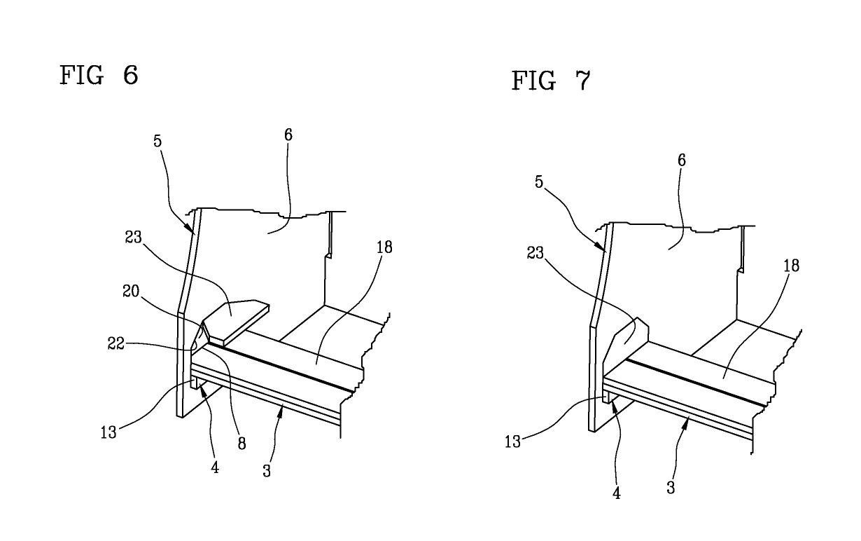

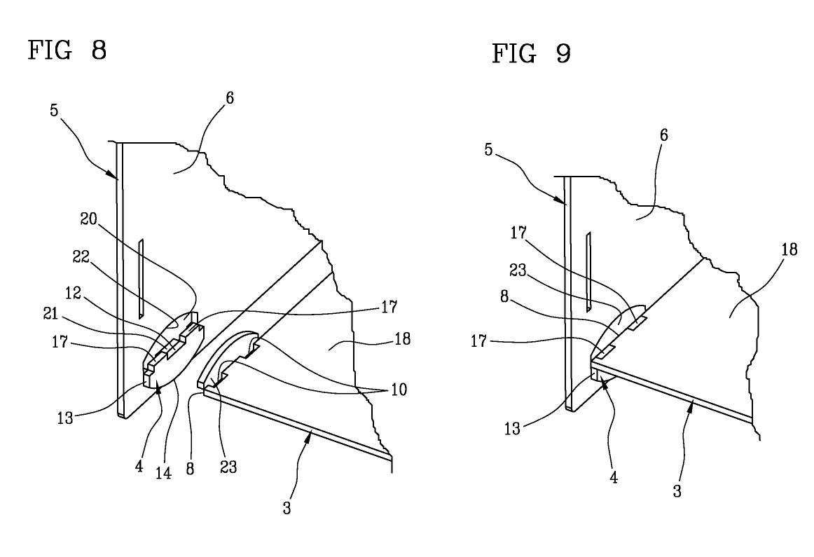

In both of the embodiments illustrated in FIGS. 1 to 7, each shelf 3 is supported by two supports 4, each connected to a vertical member 5. In the embodiment illustrated in FIGS. 8 and 9, on the other hand, each shelf 3 is supported by four supports 4. In this case, each vertical member 5 comprises two supports 4 for each shelf 3.

Each support 4 comprises at least one tongue 17 slotted into a hole 10 made in the shelf 3. The joint between the tongue 17 and the hole 10 prevents the shelf 3 from sliding relative to the support 4 in a horizontal plane “A”.

The term horizontal plane “A” is used to mean a plane parallel to the supporting surface 18 of the shelf 3.

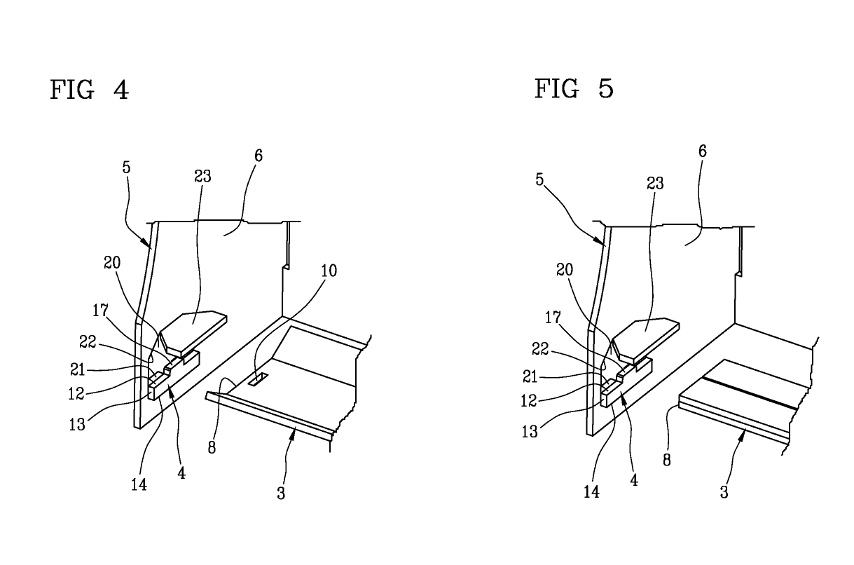

More specifically, the tongue 17 comprises a further portion of the vertical member 5. In other words, the tongue 17 extends away from the support 4 in a direction substantially parallel to the vertical member 5. The tongue 17 is made as one with the support 4. In the embodiment of FIG. 1, the tongue 17 extends from the support 4 for a length equal to the thickness of the shelf 3. In the embodiment illustrated in FIGS. 4 to 7, the tongue 17 extends from the support 4 for a length equal to half the thickness of the shelf 3. Advantageously, that means that when the tongue 17 is slotted into the hole 10 it does not protrude from the supporting surface 18 of the shelf 3 and does not therefore interfere with the goods placed on the shelf 3.

Further, the horizontal section of the tongue 17 is rectangular in shape. The term horizontal section is used to mean a section of the tongue 17 perpendicular to the direction in which the tongue 17 is slotted into the hole 10.

Preferably the hole 10 is a through hole. In the embodiment of FIG. 7 the hole 10 is not a through hole but is a blind hole 10 whose extension is substantially equal to half the thickness of the shelf 3 In this embodiment, the shelf 3 is made by folding a blank onto itself.

Regardless of the embodiment, the hole 10 is also rectangular in shape. In other words, the hole 10 is shaped to match the tongue 17. More specifically, the hole 10 is shaped to match the horizontal section of the tongue 17. Advantageously, this allows the support 4 to securely retain the shelf 3 and prevent it from moving in the horizontal plane “A”.

In the embodiment of FIG. 8, each support 4 comprises two tongues 17, each able to be slotted into a respective hole 10.

Each vertical member 5 also has at least one opening 20. The opening 20 is at least partly formed by the folded portion of the vertical member 5. Each of the ends 8, 9 of the shelf 3 is slotted into a respective opening 20. The opening 20 also has one side 21 for supporting the shelf 3. The term supporting side 21 is used to denote that portion of the edge 22 of the opening 20 that is in contact with the shelf 3.

Each opening 20 is at least partly formed by the portion of the vertical member 5 that is folded to give shape to the support 4.

The opening 20 of the vertical member 5 is at least partly engaged by a panel 23 to stop the shelf 3 on the supporting side 21. In a first embodiment, illustrated in FIGS. 1 to 3, the panel 23 is made as one with the shelf 3 and is formed by a folded portion of the shelf 3. In a second embodiment, shown in FIGS. 4 to 7, the panel 23 is made as one with the vertical member 5 and is formed by a folded portion of the vertical member 5. That portion of the vertical member 5 is different from the portion of the vertical member 5 that forms the support 4.

Moreover, the shelf 3 does not extend outwards through the opening 20. In other words, the shelf 3 does not protrude from the outside surface 7 of the upright 5. Advantageously, that means the outside surfaces 7 of the vertical members 5 of the product display case 1 are free of irregularities. It is therefore possible to apply a cover on the outside surfaces 7 in such a way that any writing on the cover is fully legible.

In some embodiments, the shelf 3 comprises a side wall 25. The side wall 25 is made as one with the shelf 3 and has a first end 26 and a second end 27. The side wall comprises two protrusions 28, each connected to a respective end 26, 27 of the side wall 25.

In a first embodiment, shown in FIGS. 1 to 3, each protrusion 28 forms a respective panel 23 that slots into the opening 20 in the vertical member 5. In a second embodiment, not illustrated, the protrusion 28 forms a further panel that slots into the opening 20 in the vertical member 5 together with the panel 23 as one with the shelf 3.

It should be noted that the panel 23 or the panel 23 plus the further panel (depending on the embodiment) completely closes (or close) the opening 20 in the vertical member 5 in conjunction with the end 26, 27 of the shelf 3 that is slotted into the opening 20. That way, the shelf 3 is stopped from sliding in the plane perpendicular to the horizontal plane “A”.

Each protrusion 28 can be slotted into a portion of a respective opening 20 in order to stop the side wall 25.

In an embodiment not illustrated, the shelf 3 comprises a weakening line located substantially at the centre line and parallel to the vertical member 5. This allows the shelf 3 to fold along the weakening line. Advantageously, that makes it possible to reduce the overall dimensions of the product display unit 1 when disassembled for transport purposes.

The frame 2 also comprises a rear wall. In the embodiment shown in FIG. 1, the rear wall is made as one with the vertical members 5. In an embodiment not illustrated, on the other hand, the rear wall is joined to the vertical members 5 by means of protuberances located along two opposite lateral edges of the rear wall. These protuberances fit into slots made in the vertical members 5. In other words, the frame 2 may be made from a single blank, made for example of honeycomb material. Alternatively, the frame 2 may be made by joining three blanks.

In one embodiment, the frame 2 may comprise a front cover (not illustrated). This cover has one or more protuberances at two ends of it, each adjacent to a respective vertical member. Each protuberance can be inserted into a slot made in a respective vertical member 5 in such a way as to stop the front cover.

The product display case 1 is made from at least one blank of honeycomb material. More specifically, the frame 2 and the shelf 3 are each made from at least one blank of honeycomb material.

The term honeycomb material is used to denote a material consisting of two skins with filling material interposed between them. In one particular case, both the skins and the filling material may be made of the same material, such as polypropylene, for example. More in detail, parallel strips of polypropylene can be interposed between two polypropylene skins, oriented perpendicularly to the skins to act as filling material. This arrangement confers stiffness on the panel allowing it to sustain loads such as, for example, the weight of the goods placed on the shelf.

The blanks can be folded along the weakening lines on the material. The weakening lines are made by cutting the sheet in such a way as to cut through only one of the two skins and the filling material under it. Thanks to its flexibility, the skin that remains whole allows the sheet to be folded along the cut in hinge-like fashion.

To assemble a product display case 1 starting from the blanks, it is necessary to fold onto the inside surface 6 of the vertical member 5 the portion of the vertical member 5 that forms the support 4. An opening 20 in the vertical member 5 is thus formed. In the embodiment of FIG. 8, which requires four supports 4 to sustain the shelf 3, this operation must be repeated a second time for each vertical member 5. The tongues 17 of the supports 4 are then slotted into the respective holes 10 in the shelves 3. In the embodiment of FIG. 4, the shelf 3 must be made ready for assembly by folding two portions of the shelf 3 upwards along two weakening lines made on the shelf 3 and perpendicular to the vertical member 5. Advantageously, this allows the flexural stiffness of the shelf 3 to be increased.

In a first embodiment, the panel 23 obtained from the shelf 3 is folded and slotted into the opening 20 in order to secure the shelf 3 in place. In a second embodiment, the panel 23 obtained from the vertical member 5 is folded

In the embodiment which comprises a rear wall made separately from the vertical members 5, the rear wall can be assembled by slotting each protuberance into the respective slot. The procedure is similar to assemble the front cover.

The invention achieves the above mentioned aims. In particular, the shelf is sustained by the supports obtained from the vertical members. Further, the tongues made on the supports slot into the holes made in the shelf and secure it to the vertical members, holding the shelf firmly in place. This makes the shelf stable even if it is struck accidentally.

The product display case according to the invention is also easy to assemble, since slotting the tongues into the holes is all that is necessary to fix the shelf on each support.

The product display case according to the invention also brings an important advantage. The type of joint used to fix the shelves is such that the outside surfaces of the vertical members remain free of irregularities so that covers bearing information or advertising can be applied to them.

This specification describes the advantageous use of a honeycomb material for making the blanks. According to other possible embodiments, the blanks might also be made from compact materials of adequate thickness and suitable for blanking, of a kind normally available on the market.

1. A product display case comprising: a frame (2) comprising two vertical members (5), each vertical member (5) having an outside surface (7) and an inside surface (6), the inside surfaces (6) being positioned to face each other; and at least one shelf (3); the display case being characterized in that the shelf (3) comprises a first end (8) and a second end (9), each engaged by a respective support (4) on each vertical member (5); the support (4) comprising a portion of the vertical member folded onto the inside surface (6) of the vertical member (5) and a tongue (17) slotted in a hole (10) made in the shelf (3).

2. The display case according to claim 1, characterized in that the tongue (17) is made as one with the support (4).

3. The display case according to claim 1, characterized in that the tongue (17) extends away from the support (4) in a direction substantially parallel to the vertical member (5).

4. The display case according to claim 1, characterized in that the hole (10) is a through hole.

5. The display case according to claim 3, characterized in that the tongue (17) extends away from the support (4) for a length equal to the thickness of the shelf (3).

6. The display case according to claim 1, characterized in that the hole (10) is shaped to match the tongue (17).

7. The display case according to claim 1, characterized in that each vertical member (5) has at least one opening (20) at least partly defined by the folded portion of the vertical member (5); the first end (8) and the second end (9) of the shelf (3) being slotted into a respective opening (20).

8. The display case according to claim 7, characterized in that the shelf (3) does not extend beyond the outside surface (7) of the vertical member (5).

9. The display case according to claim 7, characterized in that the opening (20) in the vertical member (5) is at least partly closed by a panel (23) in order to secure the shelf (3) in the opening (20).

10. The display case according to claim 9, characterized in that the panel (23) is made as one with the shelf (3) and is defined by a folded portion of the shelf (3).

11. The display case according to claim 9, characterized in that the panel (23) is made as one with the vertical member (5) and is defined by a folded portion of the vertical member (5).

12. The display case according to claim 1, characterized in that each vertical member (5) comprises two supports (4) for supporting a shelf (3).

13. The display case according to claim 9, characterized in that the shelf (3) comprises a side wall (25) made as one with the shelf (3), said side wall (25) having a first end (26) and a second end (27); the side wall (25) also comprising two protrusions (28), each connected to a respective end (26, 27) of the side wall (25) and designed to be slotted into a portion of a respective opening (20) to lock the side wall (25) in place.

14. The display case according to claim 1, characterized in that the shelf (3) comprises a weakened crease line located substantially along the centre line and parallel with the vertical member (5).

15. The display case according to claim 1, characterized in that the frame (2) and the shelf (3) are each obtained from at least one blank made of honeycomb material.
